(19) United States
(12) Patent Application Publication
(10) Pub. No.: US 2016/0176236 A1
(43) Pub. Date: Jun. 23, 2016

(54) PNEUMATIC TIRE

(71) Applicant: TOYO TIRE & RUBBER CO., LTD., Osaka (JP)

(72) Inventor: Yoshiki Sato, Osaka-shi (JP)

(73) Assignee: TOYO TIRE & RUBBER CO., LTD., Osaka (JP)

(21) Appl. No.: 14/973,321

(22) Filed: Dec. 17, 2015

(30) Foreign Application Priority Data
Dec. 22, 2014 (JP) 2014-259284

(51) Int. Cl. B60C 11/13; B60C 11/03

(52) U.S. Cl. CPC B60C 11/1315; B60C 11/0327; B60C 2011/133; B60C 2011/0334; B60C 2011/0341

(57) ABSTRACT

Provided is a pneumatic tire that includes a tread that defines at least one groove that is formed in a center area of the tread, the at least one groove being connected to a connected groove that is formed close to a shoulder part, and a guide side wall that is formed on a stepping-in side of the groove and includes an inclined surface inclined from a surface of a land of the tread toward a groove depth side. The inclined surface is curved to approach the shoulder part as it goes from its portion far from the connected groove to its portion close to the connected groove.

### CROSS-REFERENCE TO RELATED APPLICATION

This application claims the benefit of Japanese Patent Application No. 2014-259284, filed on Dec. 22, 2014, which is incorporated herein by reference.

### BACKGROUND OF THE INVENTION

1. Field of the Invention

The present invention relates to a pneumatic tire that is excellent in drainage performance.

2. Background Art

In a pneumatic tire (hereinafter, referred to as “tire”), it is important to assure drainage performance for suppressing hydroplaning phenomenon which may occur when the vehicle is moving especially at a high speed, in which a water film is built up between the tire tread and the road surface, thereby causing the tire to lose total or partial contact with the road surface and hence causing the tire to ride on the water film on the road surface.

In particular, it is important to assure drainage performance in a center area of a tread and thereby instantly drain water from the center area for a high handling stability on a wet road.

JP 2000-247111 A discloses “a pseudo land” that is formed in a center area with an inclined surface, through which water changes flow direction. However, this “pseudo land” projects from a rib located along a tire equator and extend in a tire width direction and therefore is located away from an “inclined groove” through which water passes, so that the direction of flow of drained water does not stabilize. In view of this, there is room for improvement on the drainage performance in the center area.

### SUMMARY OF THE INVENTION

The present invention therefore provides a pneumatic tire that can instantly drain water from the center area.

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

According to the present invention, there is provided a pneumatic tire including: a tread that defines at least one groove that is formed in a center area of the tread, the at least one groove being connected to a connected groove that is formed close to a shoulder part, and a guide side wall that is formed on a stepping-in side of the groove and includes an inclined surface inclined from a surface of the land of the tread toward a groove depth side, wherein the inclined surface is curved to approach the shoulder part as it goes from its portion far from the connected groove to its portion close to the connected groove

In the aforesaid pneumatic tire, the guide side wall may be inclined so that its portion close to the connected groove is sharply inclined as compared with its portion far from the connected groove and its intermediate portion therebetween.

Further, in the aforesaid pneumatic tire, the guide side wall may be a side wall close to a tire equator of the groove.

Further, in the aforesaid pneumatic tire, it may be configured so that the guide side wall has an end edge on an outer side in a tire radial direction in a portion of the groove, which portion is located far from the connected groove, the end edge being parallel to the tire equator.

Further, in the aforesaid pneumatic tire, it may be configured so that the at least one groove includes plural grooves, in which a groove thereof on one side area and a groove thereof on the other side area of the tread in a tire width direction with the tire equator therebetween are alternately arranged in a tire circumferential direction.

### BRIEF DESCRIPTION OF THE DRAWINGS

The foregoing and other features of the present invention will become apparent from the following description and drawings of an illustrative embodiment of the invention in which:

FIG. 1 is a perspective view of a certain area of a tire tread, showing a tread pattern of a pneumatic tire according to an embodiment of the present invention.

FIG. 2 is a schematic view of an inclined main groove taken out of the tire tread of the pneumatic tire as viewed from the tire radial direction.

FIG. 3 is an enlarged perspective view of a main part of the pneumatic tire, showing a certain area taken out of the tire tread, specifically a first inclined main groove and a second inclined main groove.

FIG. 4A is an enlarged perspective view of a main part of the pneumatic tire, showing a cross sectional shape of the first inclined main groove taken in the tire radial direction, in which the first inclined main groove is cut at a position on an advance side of the tire rotational direction.

FIG. 4B shows a cross sectional shape of the first inclined main groove taken in the tire radial direction, in which the first inclined main groove is cut at a position on a delay side of the tire rotational direction compared with the position of FIG. 4A.

FIG. 4C shows a cross sectional shape of the first inclined main groove taken in the tire radial direction, in which the first inclined main groove is cut at a position on a delay side of the tire rotational direction compared with the position of FIG. 4B.

FIG. 5 is an enlarged view of a main part of the pneumatic tire showing the first inclined main groove taken out of the tire tread.

### DETAILED DESCRIPTION OF THE PREFERRED EMBODIMENT

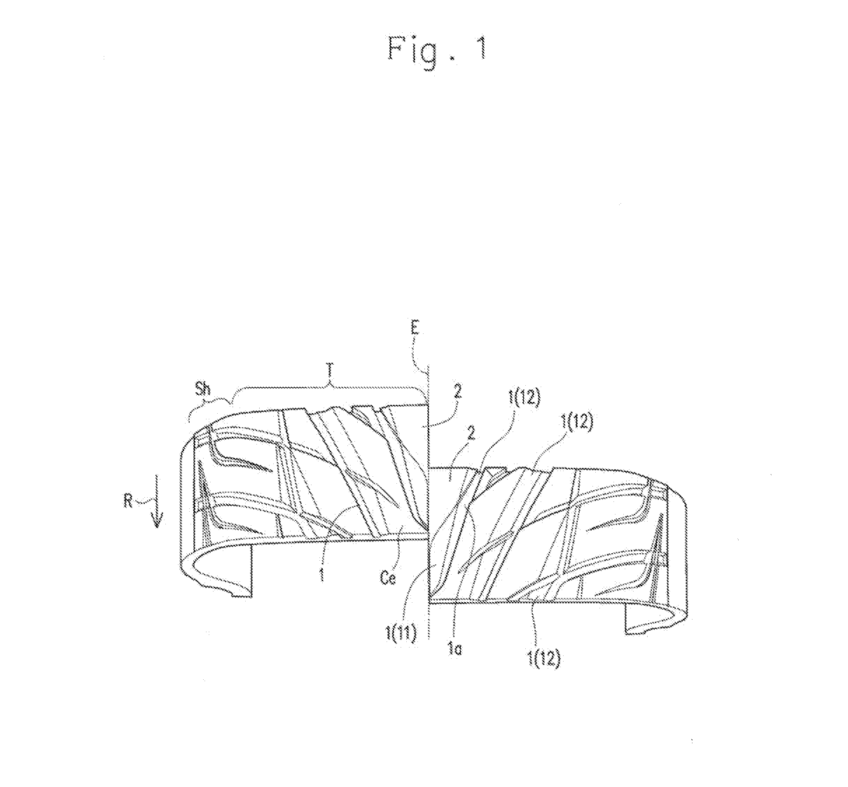

The description is given for a pneumatic tire according to one embodiment of the present invention. FIG. 1 is a view showing a tread pattern of a tire of the present embodiment, and specifically a view of a certain area taken out of the tire tread, showing one side area and another side area in the tire width direction (the right and left direction in FIG. 1) with a tire equator E therebetween, in which the first side area and the second side area are displaced to each other in the tire circumferential direction.

### Brief Overview

The tread pattern of the tire is a “center rib pattern” having a center rib 2 formed in a center area Ce of a tread T, and appearing asymmetrically with reference to the tire equator E shown in FIG. 1. More specifically, while the groove shape itself is symmetrically formed with reference to the tire equator E, the one side area and the other side area in the tire width direction with the tire equator therebetween are displaced 1/2 pitch in the tire circumferential direction to each other so that the groove shape asymmetrically appears.

The tire is attached to the vehicle so as to rotate in a tire rotation direction R shown in FIG. 1. The lower side and the upper side shown in FIG. 1 represent an advance side and a delay side of the tire rotation direction R, respectively. Also, the lower side and the upper side shown in FIG. 1 represent a kicking-out side and a stepping-in side, respectively. The tire is of a “one-way type”, which is used with the rotational direction constant. Since the tire is of the “one-way type”, the directionality of the tread pattern remains constant with respect to the tire rotation direction R. Therefore, it is possible to constantly produce the functions of a later-described inclined main groove 1 (drainage performance, rigidity of lands (blocks)).

### Inclined Main Groove

Plural inclined main grooves 1 are formed in the tread T. Each inclined main groove 1 is a groove formed between each pair of lands, and is formed to be inclined relative to the tire equator E as viewed in the tire radial direction so as to be directed from a center area Ce to a shoulder part Sh of the tread. As shown in FIG. 1, formed in the tread T are a narrow groove cured so as to cross the inclined main groove 1, and a narrow groove reaching the shoulder part Sh. A detailed description for these narrow grooves is herein omitted.

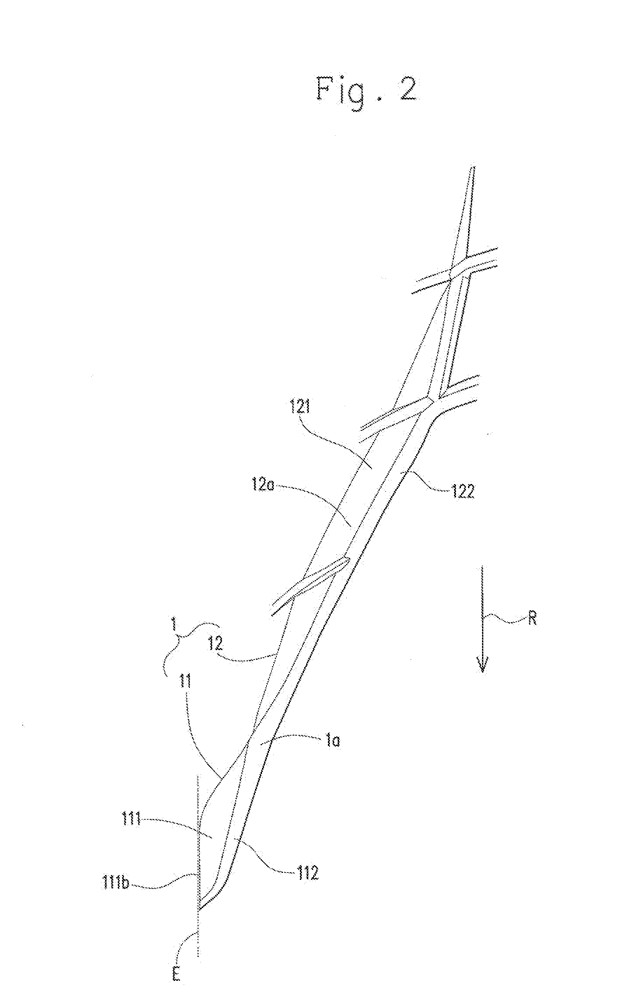

As shown in FIG. 1, three inclined main grooves 1 are formed adjacent to each other in one side area in the tire width direction of the tire equator E (corresponding to one side in a vehicle inside-outside direction when the tire is attached to the vehicle). In FIG. 1, the tread T is cut out to a certain extent in a rectangular shape in the tire circumferential direction, and therefore the overall appearance of the inclined main groove 1 is not shown. Thus, one inclined main groove 1 taken out of the tread T is shown in FIG. 2.

The inclined main groove 1 produces a function of guiding water toward the shoulder part Sh when the tread T is grounded. The direction in which the drained water passes through the inclined main groove 1 is opposite to the tire rotation direction R. Therefore, the tire can have a good water drainage performance. The inclined main groove 1 is composed of successive formation of a first inclined main groove part 11 that is located close to the tire equator E, and a second inclined main groove 12 that is located far from the tire equator E. That is, the first inclined main groove part 11 is a groove part that is formed in the center area Ce of the tread T, and is connected to the second inclined main groove 12 that serves as a connected groove formed close to the shoulder part Sh of the tread T. The first inclined main groove part 11 is located on the advance side of the tire rotation direction R, and the second inclined main groove 12 is located on the delay side of the tire rotation direction R.

As shown in FIG. 2, the width of the first inclined main groove part 11 increases as it approaches the delay side (upper side in FIG. 2) of the tire rotational direction R, then decreases and is connected to the second inclined main groove 12. The width of the second inclined main groove 12 increases from its connection part la with the first inclined main groove part 11 as it advances toward the delay side of the tire rotation direction R. Therefore, the inclined main groove 1 has a constriction shape as viewed in the tire radial direction at the connection part la of the first inclined main groove part 11 and the second inclined main groove 12. Provision of the constriction shape at the connection part la secures an area of a land (specifically a center rib 2) in the center area Ce of the tread T and hence contributes to the straight advance stability of the vehicle. Further, the thus constricted connection part la provides an enhanced aesthetic appearance which appeals to users.

As shown in FIG. 1, the inclined main groove 1 formed in the one side area and the inclined main groove 1 formed in the other side area in the tire width direction with the tire equator E therebetween are provided alternately while being displaced 1/2 pitch in the tire circumferential direction to each other. With this configuration, the inclined main groove 1 formed on the one side area and the inclined main groove 1 formed on the other side area are alternately grounded. Thus, the water drainage performance can be equally provided in the circumferential direction, and water can be alternately drained by both side areas, which results in a good drainage performance. Also, since the inclined main groove 1 formed on the one side area and the inclined main groove 1 formed on the other side area are not grounded at the same time, the hammering noise caused when they are grounded can be reduced.

The land between the inclined main grooves 1 aligned in the tire circumferential direction in the center area Ce of the tread T serves as the center rib 2. The center rib 2 can secure the rigidity of the center area Ce and hence contributes to a good straight advance stability of the vehicle. Plural center ribs 2 formed alternately in the one side area and the other side area are located adjacent to each other to have the lands connected to each other with the tire equator E therebetween, as shown in FIG. 1. This configuration also can suppress deforming or collapsing of the center rib 2 and hence secure the rigidity of the center area Ce.

### First Inclined Main Groove

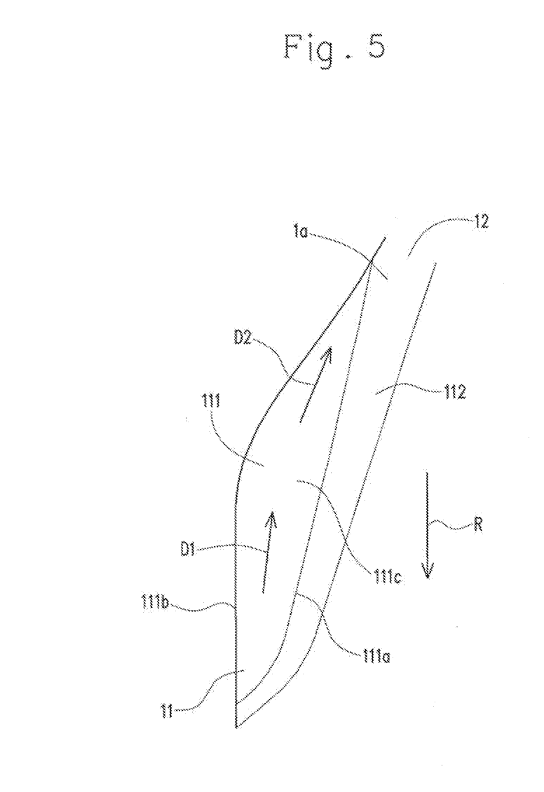

The first inclined main groove part 11 includes a guide side wall 111 and a first bottom groove part 112. The guide side wall 111 is a side wall on one side in the groove width direction of the first inclined main groove part 11, and, as shown in FIGS. 2, 3 and 5, is formed on the stepping-in side of the first inclined main groove part 11. Thus, the guide side wall 111 is provided to the first inclined main groove part 11 itself, so that water can be made to stably flow into the second inclined main groove 12 as compared with the configuration in which an inclined surface is located away from a groove through which drained water is made to pass. The guide side wall 111 also has a dimension in the tire width direction which increases as it advances toward the delay side (upper side in Figures) of the tire rotation direction R, then decreases in the same manner as the groove width of the first inclined main groove part 11, and, as shown in FIG. 5, is maximized at a center part 111c of the guide side wall 111.

The guide side wall 111 is a side wall on the tire equator E-side of the first inclined main groove part 11. Therefore, water located on the land of the center area Ce of the tread T is guided along the inclined surface of the guide side wall 111 from the tire equator E, and thereby can be guided to the bottom part (first bottom groove part 112) of the first inclined main groove part 11, so that smooth formation of flow of drained water in a direction away from the tire equator E in the tire width direction can be realized.

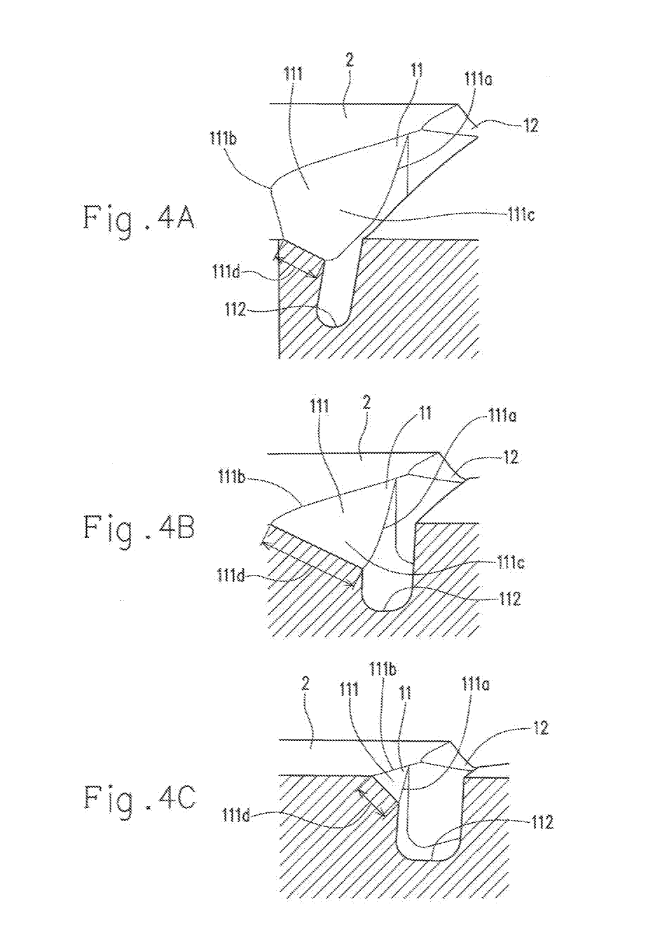

The guide side wall 111 has an inclined surface that is inclined from the surface of the land of the tread T toward a groove depth side. As shown in FIG. 4(a) to FIG. 4(c), this inclined surface has a cross sectional shape which appears as a straight line when taken in the direction crossing the direction in which the first inclined main groove part 11 extends. As shown in FIG. 5, this inclined surface is curved to extend from the center area Ce toward the shoulder part Sh as it goes from its portion far from the second inclined main groove 12 (the portion on the advance side of the tire rotation direction R in the present embodiment) to its portion close to the second inclined main groove 12 (the portion on the delay side of the tire rotation direction R in the present embodiment). In FIG. 5, directions in which phantom lines that each lie at an equal distance from a groove deep end edge 111a of the guide side wall 111 and a tire radially outward end edge 111b extend, are respectively indicated as a direction D1 in a portion far from the second inclined main groove 12, and as a direction D2 in a portion close thereto for short. This curvature can guide water on the guide side wall 111 to the second inclined main groove 12 while changing the direction of the water flow, as the tire rotates. As shown in FIG. 5, in association with the inclined surface of the first inclined main groove part 11 which is curved, the radially outward end edge 111b is also curved to extend from the center area Ce toward the shoulder part Sh as it approaches the second inclined main groove 12. The inclined surface of the guide side wall 111 is formed with a curvature as described above. However, the inclined surface may be formed by, for example, successive linear surfaces which are bent to form a curvature, and it is essential that the inclined surface is oriented so as to extend from the center area Ce to the shoulder part Sh.

A distance 111d between the groove deep end edge 111a of the guide side wall 111 and the land surface is small at an end far from the second inclined main groove 12 as shown in FIG. 4(a), gradually increases and is maximized at a center part 111c of the guide side wall 111 as shown in FIG. 4(b), and gradually decreases and becomes again small as approaching the connection part 1a with the second inclined main groove 12, as shown in FIG. 4(c). That is, the groove deep end edge 111a has a curvature extending through a deepest part of the groove at the center part 111c (a part of the curvature appears in FIG. 4(a)). Therefore, the inclined surface of the guide side wall 111 is inclined to increase in depth (depth from the land surface) toward the center part 111c. Therefore, water present in the area on the kicking-out side of the guide side wall 111 can be guided to the first bottom groove part 112 while being directed to the center part 111c.

The inclined surface of the guide side wall 111 becomes gradually smaller as it goes from the center part 111c toward the connection part 1a with the second inclined main groove 12. That is, as is being apparent from the comparison between FIGS. 4(a) to 4(c), the proportion of the volume occupied by the first bottom groove part 112 in the volume of the first inclined main groove part 11 increases. Therefore, the first inclined main groove part 11 is configured so that, as going from the center part 111c toward the connection part 1a with the second inclined main groove 12, water which has been already collected in the first bottom groove part 112 is directed to the second inclined main groove 12 more preferentially to guiding water to the first bottom groove part 112 via the guide side wall 111. Therefore, water drainage into the second inclined main groove 12 can be efficiently performed.

Further, the inclined surface of the guide side wall 111 has such a shape that it is twisted while rising up as it approaches the second inclined main groove 12. That is, as compared with a portion far from the second inclined main groove 12 and an intermediate portion shown respectively in FIGS. 4(a) and 4(b), a portion close to the second inclined main groove 12 shown in FIG.

4(c) is sharply inclined. Therefore, in an area between the portion far from the second inclined main groove 12 and the intermediate portion where the inclination is relatively gentle, water is preferentially guided to the second inclined main groove 12. On the other hand, in an area between the intermediate part and the part close to the second inclined main groove 12, where the inclination is relatively sharp, the guide side wall 111 acts like a “wall” against the flow of water guided to the second inclined main groove 12 due to the curvature of the guide side wall 111 because of the sharp inclination, water is prevented from going out onto the land over the first inclined main groove part 11 while can be made to flow along the first bottom groove part 112. Thus, in an area between the intermediate portion and the portion close to the second inclined main groove 12, water flowing through the first bottom groove part 112 is guided to the second inclined main groove 12 preferentially to the guiding of water to the first bottom groove part 112.

In other words, the inclination in an area between the portion far from the second inclined main groove 12 and the intermediate portion is such an inclination as to guide water to the first bottom groove part 112, and the inclination in an area between the intermediate portion and the portion close to the second inclined main groove 12 is such an inclination as to guide water to the second inclined main groove 12. Thus, the function preferentially provided in an area far from the second inclined main groove 12 in the guide side wall 111 is different from the function preferentially provided in an area close to the second inclined main groove 12. Therefore, water drainage to the second inclined main groove 12 can be efficiently performed.

As shown in FIG. 2, of the guide side wall 111, the radially outward end edge 111b in a portion of the first inclined main groove part 11 far from the second inclined main groove 12 is parallel to the tire equator E as viewed in the tire radial direction. Therefore, the distance between the radially outward end edge 111b and the tire equator E is constant so that water on the land (center rib 2) of the center area Ce can be guided to the guide side wall 111 evenly in the tire circumferential direction.

In particular, in the present embodiment, the radially outward end edge 111b substantially coincides with the tire equator E. Specifically, the radially outward end edge 111b is located at a position close to the tire equator E but not exceeding the tire equator E. Therefore, water present on the tire equator E when the tire is grounded can be made to very rapidly flow into the first inclined main groove part 11. Thus, it is possible to suppress occurrence of hydroplaning phenomenon which is caused by a water film on which the part of the tire equator E of the tread T rides on.

The aforesaid inclination is so that the guide side wall 111 in a portion where the radially outward end edge 111b is parallel to the tire equator E is inclined in the tire width direction and is inclined in a direction away from the tire equator E to the groove depth side. That is, this inclination is an inclination parallel to the tire equator E. Thus, it is possible to guide water located between the road surface and the center rib 2 to the first inclined main groove part 11, and, at the same time, secure the rigidity of the land as compared with the case where the guide side wall 111 is composed of a wall surface parallel to the tire equator E and perpendicular to the land. As a result, a high straight-traveling stability is obtainable.

As described above, the inclined main grooves 1 respectively formed on the one side area and the other side area of the tread T in the tire width direction with the tire equator E therebetween are alternately formed in the tire circumferential direction. Thus, the same is also applicable to the first inclined main groove part 11. That is, the first inclined main groove parts 11 respectively formed on the one side area and the other side area of the tread T in the tire width direction are alternately formed in the tire circumferential direction with reference to the tire equator E. Therefore, as described above on the inclined main groove 1, the first inclined main groove part 11 formed on the one side area and the first inclined main groove part 11 formed on the other side area are alternately grounded. Therefore, even by the first inclined main groove parts 11, the water drainage performance can be equally provided in the tire circumferential direction, and water can be alternately drained by both side areas, which results in a good drainage performance.

As described above, water present in the center area Ce can be instantly drained by providing the center area Ce of the tread T with the first inclined main groove parts 11. This configuration is especially effective in a tire of a “center rib pattern” like the present embodiment in view of suppressing the hydroplaning phenomenon.

### Second Inclined Main Groove

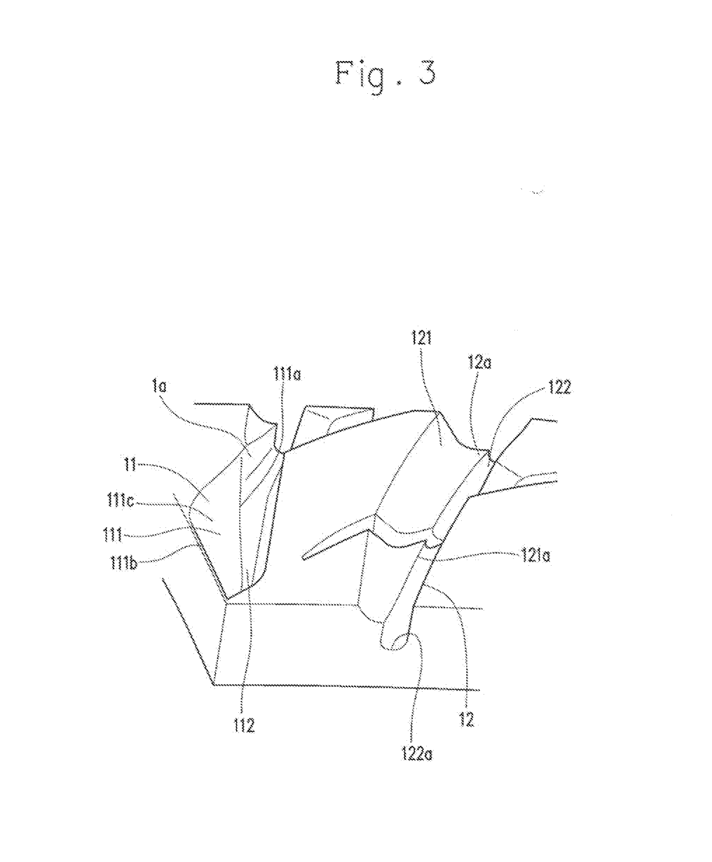

As shown in FIG. 3, the second inclined main groove 12 has a curved inclined part 121 and a second bottom groove part 122 that is located adjacent to one side of the curved inclined part 121 in the groove width direction. The curved inclined part 121 is a concave inclined surface that is inclined from the surface of the land toward a groove depth side. This concave surface is a curved surface, of which a cross sectional shape taken in a direction crossing a direction in which the second inclined main groove 12 extends appears as a curving line concave toward the inside of the tire. The second bottom groove part 122 is located adjacent to the curved inclined part 121 through a stepped portion 12a. This stepped portion 12a has such a shape that the second bottom groove part 122 is concave toward the groove depth side from the curved inclined part 121. Thus, a bottom surface 122a of the second bottom groove part 122 is located on a side deeper than or located on an inner side in the tire radial direction than a groove deep end edge 121a of the curved inclined part 121.

With the above configuration, in which the second inclined main groove 12 includes the second bottom groove part 122 having the inclined surface, the groove width of the bottom portion can be set to be smaller in dimension than the groove having a simple rectangular cross section. Thus, the tire rigidity can be secured. Further, with the above configuration, in which the inclined surface of the curved inclined part 121 is a concave surface, an increased groove volume by a concave amount can be secured as compared with a flat surface. As the tire rotates, water is guided along the curved inclined part 121 to the second bottom groove part 122, then is made to pass through the second bottom groove part 122 that is located inward of the curved inclined part 121 in the tire radial direction by the stepped portion 12a and hence drained. Therefore, water is mainly guided in the curved inclined part 121, and is mainly collected in the second bottom groove part 122 and is made to flow therein in the extending direction of the second inclined main groove 12. That is, the curved inclined part 121 is configured exclusively to guide water, and the second bottom groove part 122 is configured exclusively to drained water. Thus, it is possible to suppress occurrence of swirling current in a groove bottom due to joining of a guided water flow and a drained water flow, and hence suppress a smooth flow of drained water from being blocked. As a result, water can be efficiently drained. Thus, the tire of the present embodiment can simultaneously achieve both functions of securing the tire rigidity and securing a good water draining performance by providing the second inclined main groove 12.

Also, the inclined surface of the curved inclined part 121, which is a concave surface, makes it possible to reduce the landing shock caused by landing on a water film on the road surface. Because of this, the second inclined main groove 12 can smoothly enter a water film on the road surface, and thereby push aside water, thereby suppressing occurrence of hydroplaning phenomenon caused by a water film on the road surface on which the tread T rides on.

As shown in FIG. 2, the end edges in the groove width direction of the second inclined main groove 12 and the end edges in the groove width direction of the first bottom groove part 112 are positioned substantially in conformity to an arc continuous in the tire circumferential direction. The arc is curved to be convex toward the tire equator E, except the end portion on the delay side in the tire rotation direction R. As shown in FIG. 2, in the end portion on the delay side of the tire rotation direction R, the second bottom groove part 122 has a straight shape extending away from the tire equator E as it approaches the delay side of the tire rotation direction R, and the curved inclined part 121 has a triangular shape having a width reduced as it approaches the delay side of the tire rotation direction R.

With the above shapes, a flow of drained water can be formed into a substantially arc shape in the most portion of the inclined main groove 1, and therefore the resistance of the drained water in the inclined main groove 1 can be reduced. Also, since the first inclined main groove part 11 (especially the first bottom groove part 112 thereof) and the second inclined main groove 12 can be seen to be integral with each other, an excellent aesthetic appearance is obtainable.

As shown in FIG. 1, the second inclined main groove 12 extends in a direction inclined relative to the tire equator E as viewed in the tire radial direction. The curved inclined part 121 is located on the stepping-in side of an inner side surface of the second inclined main groove 12. On the other hand, the inner side surface on the kicking-out side of the second inclined main groove 12 is flat substantially perpendicular to the land surface, as shown in FIG. 3. With such a configuration in which the curved inclined part 121 is located on the stepping-in side of the inner side surface of the second inclined main groove 12, water can be made to flow from the end edge on the kicking-out side of the land to the curved inclined part 121. Thus, it is possible to eliminate a water film from between the road surface and the land and thereby suppress occurrence of hydroplaning phenomenon. Also, with such a configuration in which a side surface on the stepping-in side of the land is inclined or chamfered, the land can have a rigidity (specifically a rigidity of a block adjacent to the curved inclined part 121) higher than the rigidity of a land having a perpendicular wall on its stepping-in side. Therefore, it is possible to suppress the land from deforming or collapsing onto the second inclined main groove 12 during braking operation. Thus, a good braking force is obtainable.

In the present embodiment, the curved inclined part 121 is located only on the stepping-in side of the inner side surface of the second inclined main groove 12, while being not located on the kicking-out side thereof. This is not essential. The second inclined main groove 12 may be configured such that the curved inclined part 121 is provided on each of both sides with the second bottom groove part 122 therebetween.

The depth of the curved inclined part 121 from the surface of the land is small in an area close to the center area Ce of the tread T and an area close to the shoulder part Sh of the tread T, and large in an intermediate area therebetween. Therefore, at the initial stage when the tire is grounded, the area having a small depth first contacts the road surface, then the area having a large depth contacts the road surface, and then the area having a small depth contacts the road surface. Therefore, when compared to the case where a groove having a large depth suddenly contacts a water film, the landing shock caused by landing on a water film can be reduced. Therefore, it is possible to smoothly or non-interruptingly reduce the landing shock over the sequence from stepping-in to the kicking-out, of the second inclined main groove 12.

Of each two adjacent ones of the second inclined main grooves 12 located adjacent to each other, an area of the curved inclined part 121 having a large depth in the one second inclined main groove 12 is located adjacent to an area of the curved inclined part 121 having a large depth of the other second inclined main groove 12 in the tire width direction.

Therefore, it is possible to make constant the total volume of the combination of the adjacent ones of the second inclined main grooves 12 located adjacent to each other in the tire width direction as much as possible. Thus, it is possible to suppress fluctuation of the drainage efficiency in the tire circumferential direction and hence achieve a uniform drainage efficiency. Accordingly, a stable water drainage performance can be secured. An average value of the rigidity in the tire width direction of the blocks defined by the second inclined main groove 12 can be equalized. As a result, a good handling stability can be obtained especially during running on a dry road.

### Conclusion

As described above, the tire of the present embodiment can simultaneously achieve a high travelling performance or a high handling stability on a dry road and a high travelling performance or a high water draining performance on a wet road.

The present invention is not limited to the aforementioned embodiment, and the design can be appropriately modified within the scope intended by the present invention.

As described above, the present embodiment is a pneumatic tire that includes the tread T that defines at least one groove (first inclined main groove) 11 that is formed in the center area Ce of the tread T, the at least one groove (first inclined main groove) 11 being connected to the connected groove (second inclined main groove) 12 that is formed close to the shoulder part Sh, and the guide side wall 111 that is formed on a stepping-in side of the groove (first inclined main groove) 11 and includes an inclined surface inclined from a surface of the land of the tread T toward a groove depth side, in which the inclined surface is curved to approach the shoulder part Sh as it goes from its portion far from the connected groove (second inclined main groove) 12 to its portion close to the connected groove (second inclined main groove) 12.

According to the above configuration, the guide side wall 111 provided in the groove itself makes it possible to allow drained water to stably flow as compared with the configuration in which an inclined surface is located away from a groove through which water is made to flow. Also, since the inclined surface of the guide side wall 111 is curved to approach the shoulder part Sh as it goes from its portion far from the connected groove (second inclined main groove) 12 to its portion close to the connected groove (second inclined main groove) 12, water on the guide side wall 111 can be guided toward the connected groove (second inclined main groove) 12 as the tire rotates.

The guide side wall 111 may be inclined so that its portion close to the connected groove (second inclined main groove) 12 is sharply inclined as compared with its portion far from the connected groove (second inclined main groove) 12 and its intermediate portion therebetween.

According to the above configuration, the guide side wall 111 is inclined so that its portion close to the connected groove (second inclined main groove) 12 is sharply inclined as compared with its portion far from the connected groove (second inclined main groove) 12 and its intermediate portion therebetween. Therefore, in an area between the portion far from the connected groove (second inclined main groove) 12 and the intermediate portion where the inclination is relatively gentle, water is preferentially guided to the groove bottom part. On the other hand, in an area between the intermediate portion and the portion close to the connected groove (second inclined main groove) 12 where the inclination is relatively sharp, water flowing through the groove bottom part is guided to the connected groove (second inclined main groove) 12 preferentially to the guiding of water to the groove bottom part. Thus, the function preferentially provided in an area far from the connected groove (second inclined main groove) 12 is different from the function preferentially provided in an area close to the connected groove (second inclined main groove) 12, in the guide side wall 111. Therefore, water draining to the connected groove (second inclined main groove) 12 can be efficiently performed.

The guide side wall 111 may be a side wall close to the tire equator E of the groove.

According to the above configuration, water located on the land in the center area Ce of the tread T is made to pass along the inclined surface of the guide side wall 111 from the tire equator E, so that water can be guided to the bottom part of the groove and hence a flow of drained water in a direction separating away from the tire equator E in the tire width can be smoothly formed.

The guide side wall 111 may have the end edge 111b on an outer side in the tire radial direction in a portion of the groove, which portion is located far from the connected groove (second inclined main groove) 12, the end edge 111b being parallel to the tire equator E.

According to the above configuration, the distance between the radially outward end edge 111b of the guide side wall 111 and the tire equator E is constant so that water on the land of the center area Ce of the tread T can be guided to the guide side wall 111 substantially evenly in the tire circumferential direction.

The at least one groove (first inclined main groove) 11 may include plural grooves, in which a groove thereof on one side area and a groove thereof on the other side area of the tread T in the tire width direction with the tire equator E therebetween are alternately arranged in the tire circumferential direction.

According to the above configuration, the grooves can be alternately arranged respectively on the one side area and the other side area. Therefore, a uniform water drainage efficiency in the tire circumferential direction can be achieved, and water draining can be performed alternately between both side areas as the tire rotates. Thus, a good water drainage performance is obtainable.

Thus, the pneumatic tire of the present embodiment makes it possible to guide water from the guide side wall 111 to the connected groove (second inclined main groove) 12. Therefore, it is possible to provide a pneumatic tire that can produce an effect of instantly draining water from the center area Ce via the grooves 11 and 12.

The pneumatic tire of the present embodiment is as described above. However, the present invention is not limited thereto, and the design can be appropriately modified within the scope intended by the present invention. The operational advantage of the present invention is also not limited to the foregoing embodiments. The embodiments disclosed herein should be construed in all respects as illustrative but not limiting. The scope of the present invention is not indicated by the foregoing description but by the scope of the claims. Further, the scope of the present invention is intended to include all the modifications equivalent in the sense and the scope to the scope of the claims.

What is claimed is:

1. A pneumatic tire comprising:
a tread that defines at least one groove that is formed in a center area of the tread, the at least one groove being connected to a connected groove that is formed close to a shoulder part, and
a guide side wall that is formed on a stepping-in side of the groove and includes an inclined surface inclined from a surface of the land of the tread toward a groove depth side,
wherein the inclined surface is curved to approach the shoulder part as it goes from its portion far from the connected groove to its portion close to the connected groove.

2. The pneumatic tire according to claim 1, wherein the guide side wall is inclined so that its portion close to the connected groove is sharply inclined as compared with its portion far from the connected groove and its intermediate portion therebetween.

3. The pneumatic tire according to claim 1, wherein the guide side wall is a side wall close to a tire equator of the groove.

4. The pneumatic tire according to claim 1, wherein the guide side wall has an end edge on an outer side in a tire radial direction in a portion of the groove, which portion is located far from the connected groove, the end edge being parallel to the tire equator.

5. The pneumatic tire according to claim 1, wherein the at least one groove comprises plural grooves, in which a groove thereof on one side area and a groove thereof on the other side area of the tread in a tire width direction with the tire equator therebetween are alternately arranged in a tire circumferential direction.
